(19) United States
(12) Patent Application Publication
(10) Pub. No.: US 2007/0133444 A1
(43) Pub. Date: Jun. 14, 2007

(54) Telemote: a remote control for home and entertainment use

(76) Inventor: Wayne A. Beale, Indianapolis, IN (US)

Correspondence Address: WAYNE A. BEALE, 3533 Idlewood Ter apt 1020, Indianapolis, IN, 46214, US

(21) Appl. No.: 11/298,236

(22) Filed: Dec. 9, 2005

(51) Int. Cl. H04N 5/335; H04N 5/30

(52) U.S. Cl. 370/310; 348/162

(57) ABSTRACT

A duel sided remote which has a universal television remote on one side that can also control selected home lighting. Along with other entertainment devices such as DVD player. On the opposite side there is a cordless rechargeable telephone with a sliding face cover over the numeric pad which allows protection from accidental dialing.

The invention relates to television remote controls and cordless telephone applications and function of these two devices. Combining the cordless phone with the control of a television remote and other home devices such as lighting.

In many electronic stores and in many homes across the US people have televisions and telephones. Most people now days know how to use the remote for the TV and the home cordless phone. Other devices such as the cellphone, the home PC and other everyday electronic devices have been made to perform multiple functions. Consumers have come to expect these devices to do all sorts of things such as to have control over your internet and telephone at the same time or the ability to combine your cable with your phone bill these devices give the user services that are missing a specialized tool that is functional for all such devices. In this world of electronics the consumer has come to value simplicity with the new technology. In most cases

Simplicity has become a hurdle or barrier between generations. Most people do not know how to use their PC or Lap Top to their full capabilities. Power and software go unused. The software to most Babyboomers is complicated and older groups despise the computer and the internet. Many reasons have been sited but most believe that the new technology is not compatible with their past knowledge of technology. Has technology moved so fast that it will leave people behind, never to understand? A tool has been left out of the evolutionary chain that makes the vital simple connection that helps link all these devices.

Inventors and large electronic developers have set a path for hand held devices with multiple capabilities. This is a way of feeding the new wave generation with their want for information and communication at the touch of a hand. An instant response to an actions is desired. Many do not have the need for information overload and only choose to have control over their home. The home is their kingdom and their sanctuary where they want to interface and control their home environment.

Since the first TV remote called, “Lazy Bones,” was invented in 1950 by Zenith Radio, the consumer of television and other home entertainment desire instant control. The next step in the evolution in the remote was developed by Eugene Polley in 1955. His TV remote was called the “Flash-Matic”: The Flash-Matic is a crude invention compared with today's technology. The Flash-Matic uses separate light colors to control the television's volume and channels. It was cordless, basically a flash light with alternate colors were directed at the TV to control the functions. This made it more convenient for the consumer to relax at home and change their TV, but lacked any total control and had no capability to advance with the next leaps and bounds of technology.

The next branch in the evolutionary tree of the remote was coupled with the next jump in technology. It was made by Robert Adler who based his invention on ultrasonics, which was the dominate design for 25 yrs. A strong leap in remote technology was the IR remote control system which adapted the transmitter for transmitting multibit code identifying a select function of the television via infrared. Collins; Johnny. Zenith Radio Corp. 057053 Jul. 12 1979. (398/106class). Even though control was advanced with these new developments, both were only stepping stones to new and better technology.

Infrared devices replaced ultrasonic remote controls in the early 1980's. The Universal remote, U.S. Pat. No. 4,774,511 to Rumbolt, et al (1988) made a single remote capable of adapting the signals to match the multibit code in the different television sets of the manufactures. This made the new remote very versatile. This remote laid the foreground for the great hand held devices of today such as the Palm or the Blackberry. The ability to control electronic information was driven by the consumer desire. The faster, more powerful devices were in demand, even though the consumer had not learned how to use the now out dated technology. Infrared interface and control apparatus which is for controlling consumer's electronics. U.S. Pat. No. 5,815,297 to Ciciura 3,928,760 (1998), 3,906,366 (1998) all to Minumi et al, these are representations of pulse position modulation and pulse width or modulating frequency subsequently being detected for controlling a selected function and later the VCR, DVD player, CD player, and Home receiver. The remote control by Curt Wohleber used a method including a keypad entry for device selection and function instruction and comprising steps of presently selecting a command mode for one of at least two remotely controlled devices, Invention & Technology magazine, pp 6-7, Winter 2001. This coupled with a Remote control dedicated keybutton for confirming tuner setting of a TV set channel setting, Weber; Harold J, Centerville, Mass. (2001) All of these advancements in technology have made today's technology possibly the most complex devices in history.

(a) Today's manufacture sell most new technology at high cost because of the high cost of producing the new technologies. Generally the cost may constitute a separate production site, building new production lines, and often overhead for materials are high.

(b) If multiple companies manufacture the same type of circuitry (ex. TV remote and Cordless phone) for several different types of electronic receivers, then multiple unused remotes and old phones will become a waste of materials, time and cost.

(c) These different remotes in the home can become a hassle. Having to find five remotes to control your TV, DVD, Stereo, etc; Which furthermore constantly get lost and/or run out of batteries.

(d) Cordless home phones have many similar problems. The cordless phone never seems to be in a convenient place and is hard to locate when needed.

(e) Many of the devices of today really lack the simplicity that makes them useful for everyday use in the home. The present devices do not give you total control over the luxuries of your environment.

In accordance with the present invention is a duel sided remote that is comprised of a universally adaptable entertainment remote and a cordless phone. The Telemote will be rechargeable and have a locator device. It will also have capability for pre paid use for phone services, and possible wireless internet.

Accordingly, besides the objection and advantages of the Telemote described in my above patent, several objections and advantages of the present inventions are:

(a) to provide a remote control that will allow you to control your television and receiver while having the convenience of a cordless phone on the other side;

(b) to provide control over selected home lighting fixtures in order to provide more control over environmental luxuries;

(c) to provide a more efficient way to answer phone calls and maintain comfort while watching television;

(d) to provide a single device that will eliminate the use of several devices to get the same effect;

(e) to provide a device that is easy to find as well as have the power needed to conduct functions desired;

(f) to provide an advancement in remote/telephone technology that is easy to use for even the computer illiterate

Further objects and advantages are to provide convenience which can be used to give the consumer more comfort in the home and to provide device versatility, which alleviates the need for several devices or remotes to have the same control that one remote can give the consumer.

In the drawings, closely related figures have the same numbers but different alphabetic suffixes.

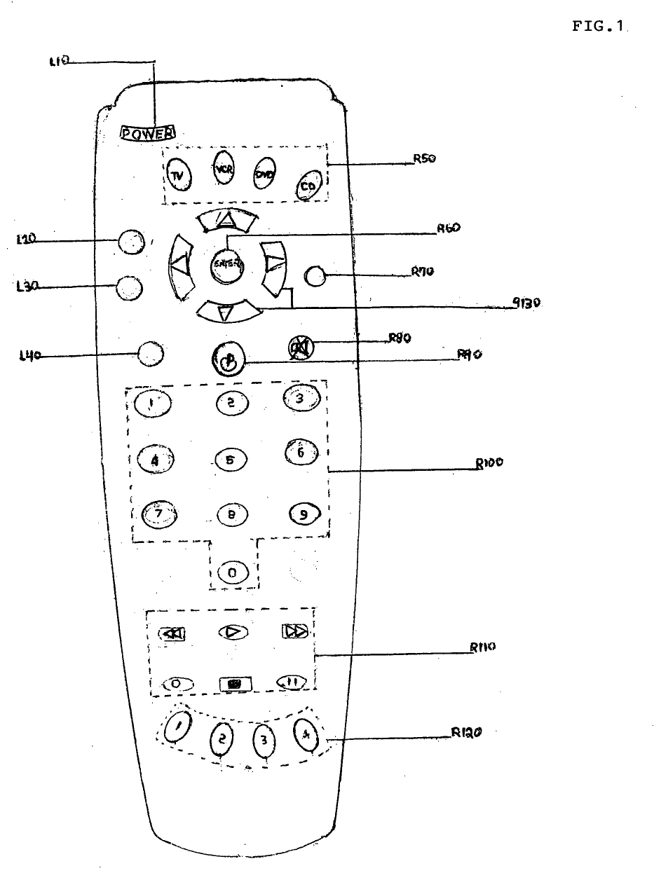

FIG. 1 shows television remote face

FIGS. L10 to R10 show various controls for television, DVD and other entertainment devices, which are supplied by push button controls

FIG. R120 shows the controls for lights, which sends the signal to the receiver on the light fixture or socket.

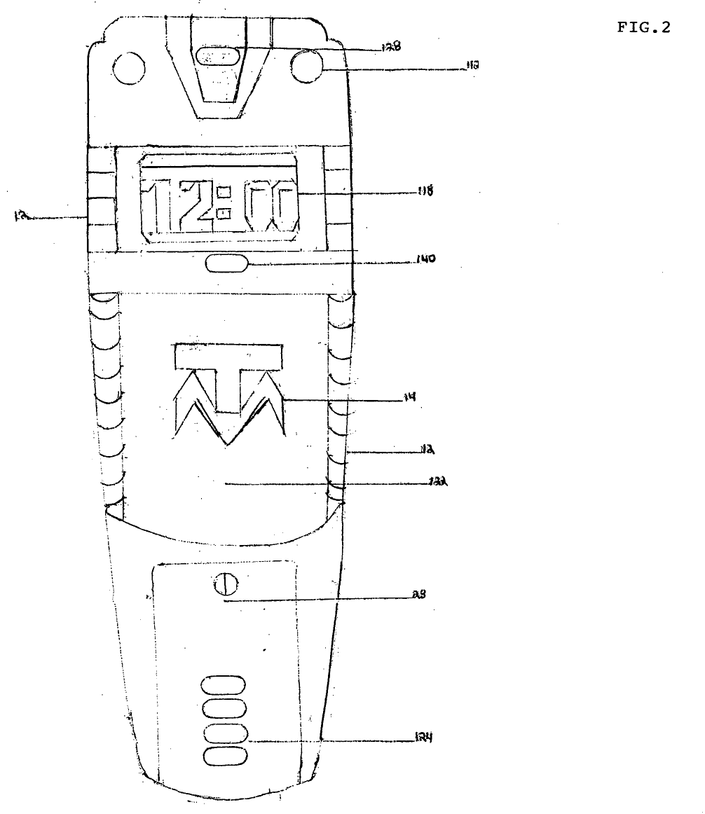

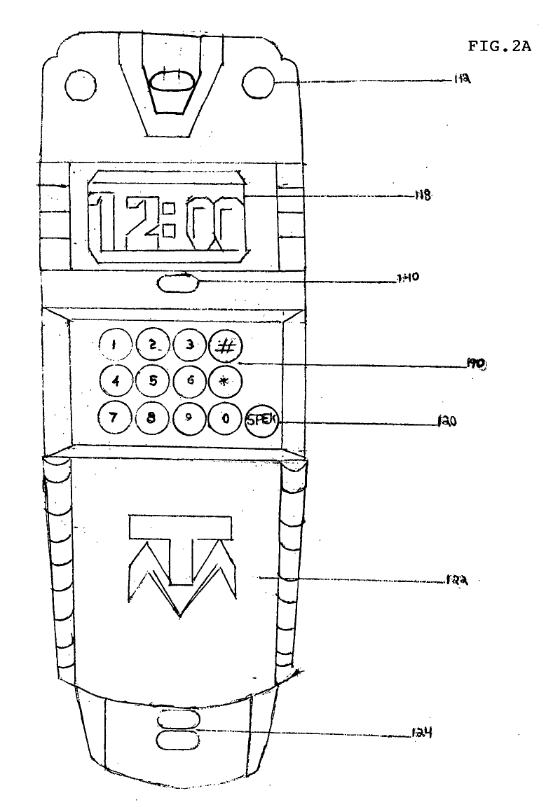

FIGS. 2 and 2A show dual side of Telemote giving the user two simple sides to use.

FIG. 2B shows the spring action cover that opens to display the dial pad.

REFERENCE NUMERALS IN DRAWINGS

| | |
|---|---|
| L10 Power Control by Individual | B112 Speaker |
| Selection | |
| L20 Mode Selection | B118 LCD Screen and Clock Face |
| L30 Alternate Excelery Controls | B140 Cover Release Button |
| (AUX) | |
| L40 Audio Set Up | B190 Dial Pad |
| R50 Entertainment Accessories | B120 Speaker Phone Control |
| Controls | |
| R60 Channel or Menu Selection | B122 Telemote Sliding Cover |
| R70 Menu Set Up | B124 Voice Communication Holes |
| R80 Volume Mute | B128 Voice Receiver |
| R90 All Power Off Control | B12 Grip Material |
| R100 Numerical Selection Controls | B14 Telemote Insignia |
| R110 Mode Selection for | B28 Battery Pack Cover |
| Entertainment Accessories | |
| R120 Controls for Selected Lighting | |
| R130 Arrow Controls | |

A top view of the embodiment shows familiar controls of a television remote control. The selected R50 entertainment accessory can be turned on or off L10. Programming frequencies of accessories units L20. Alternate auxiliary controls accessed L30 for receiver units. The audio setup controls L40 are used to switch through audio setup selection (dolby, 5.1, 3.1 etc.) Confirmation of selected channel and R70 menu selections R60 can be manipulated by R130 the arrow selections. Volume mute R80 turns all volume off. Similar to mute button R90 “kill switch” turns all accessories controlled by unit off. Channel selection is made R100 to direct control of channel selected. Slow scan, skip scan, play, pause, stop controls DVD/VCR functions. Selected lighting fixtures R120 are controlled by ultrasonic frequencies each variant to control lighting on and off.

FIG. 2 and FIG. 2A show reverse side of embodiment. At the top end is B128 the ear piece for hearing the incoming caller. The sliding cover B122 is released by B140 the button located in the center of the embodiment. The center button B140 is used to answer incoming callers as well as spring action release FIG. 2A. The sliding cover B122 slides to reveal B11 a telephone dial pad. Speaker phone B120 function is located on dial pad. Sound is transmitted B112 through the speakers located at the head of telemote unit. The sliding cover B122 can be placed back over dial pad while speaker phone function is in use. The telemote insignia B14 is located on sliding cover B122. The foam grips B12 makes use comfortable and durable. The LCD screen B118 displays the time and other information (call id, battery charge, etc.). Located at the bottom FIG. 2A is the voice receivers B124 were the user can speak to the incoming caller. A representative screw B28 shows rechargeable battery cover.

### ADVANTAGES

From the description above, a number of advantage of my remote control embodiment becomes evident:

(a) In any randomly selected home their may be several remotes used to control several electronic units, the telemote will eliminate the need for several remotes to control these devices and synthesize a single remote with multiple function capabilities, the single unit multifunctional remote control uses existing computer hardware and software along with existing production means which makes the unit very cost efficient to produce.

(b) With the use of the duel sided unit, durability and convenience can be provided to the user, a rechargeable telephone is located on the reverse side of the multifunctional unit, to avoid the need to locate another device to communicate with the outside world, which includes people, business, and our home entertainment devices.

(c) The remote also gives the user control over selected lighting fixtures by ultrasonic receivers and remote transmitter, similar to “The Clapper” device will provide convenience for the remote holder and control over the environment of the device user.

(d) A single rechargeable device will save the need for spare batteries and the user cost.

(e) The unit has grips that make use comfortable and the device durable, which prevents damage to the unit.

### OPERATION - FIGS. 1, 2, 2A

The manner of using the telemote is identical to that of the present television remotes in use. Namely, one first selects the device the user wants to turn on or off by pressing that selection. Ex. select the TV button to turn on the TV. Next select R30 volume, R60/R30 channel, R120 lighting, L40 audio set preference, etc. On the opposite side of the unit are the telephone functions. The sliding cover B122 snaps down to reveals the telephone dial pad, which is identical to that of telephones in present use. Namely, one first will decided if the call is an incoming call or if the user wants to call out B140 & B122. Once the caller has made the call B190 on the dial pad the user has the choice to use the telemote in the conventional manner similar to your home phone ex. Put the listening end to the ear and mouth or talking end to speak into. The user can B120 switch to the speaker phone function. The incoming caller's voice will come through the B12 speakers, which will allow the user to hear the caller and use the telemote's optional functions. Convenience is enhanced by B12 grips that prevent slippage and enhances comfortable usage. The LCD clock B118 allows the user to read the time. The battery is encased behind a cover B28.

### CONCLUSION, RAMIFICATION, AND SCOPE

Accordingly, the reader will see tht the telemote remote control can be useful and convenient, can be easily used without prior use of the telemote, and can be used in any home.

In addition, the telemote will reduce the need for several different remotes to do the same task that one remote can do. Furthermore, the remote has the additional advantages in that

it permits the production of a single remote by existing facility which in turn requires low investment cost for new HI-Tech technology;

it allows dual convince in a multi-functional remote, by allowing the user choice of the phone, the TV remote, or even light control;

it allows the user to have a comfortable and convenient control over their environment at the touch of a button;

it provides a rechargeable and easy to locate unit where the telemote's mother and father, the TV remote and the cordless home phone lacked the combination;

it provides grips that make the use of the telemote comfortable to hold and use, it also works to protect the unit from impact damage.

Although the description above contains many specificities, these should not be construed as limiting the scope of the invention but merely providing illustrations of some of the presently preferred embodiments of this invention. For example, the remote can have other shapes, such as circular, oval, trapezoidal, triangular, etc; the remote can be made of materials, such as plastic, metal, rubber, synthetics, etc.

Thus the scope of the invention should be determined by the appended claims and their legal equivalents, rather than the examples given.

I claim:

1. A dual sided remote control, comprising
(a) an alternating radio frequency system is the means for said remote which allows the user control over their television and other like devices
(b) an opposite side of said remote will allow user to make and receive outgoing and incoming calls
(c) a function of said remote will operate devices for lighting whereby controls given to said remote via ultrasonic frequency
